(19) United States
(12) Patent Application Publication
(10) Pub. No.: US 2026/0084457 A1
(43) Pub. Date: Mar. 26, 2026

(54) Multi-Purpose Framer's Speed Square

(71) Applicant: Glenn E. Wadsworth, Springfield, OR (US)

(72) Inventor: Glenn E. Wadsworth, Springfield, OR (US)

(21) Appl. No.: 18/898,371

(22) Filed: Sep. 26, 2024

(51) Int. Cl. B43L 7/027; B25H 7/02

(52) U.S. Cl. CPC B43L 7/0275; B25H 7/02

(57) ABSTRACT

A multi-purpose framer's speed square in the form of a right triangle comprising a top plate with a T-shaped edge and a series of etched top plate lines including framing top plate call outs, a notched front edge having a plurality of notches spaced along the length in ¼″ increments, ruler etching callouts, and lumber width callouts denoting lumber sizes, and a hypotenuse edge having etched top plate lines, common rafter window plumb cut outs and a hip/valley section disposed above the hypotenuse edge having etched degrees and hip/valley roof rafter plumb cuts.

### FIELD OF INVENTION

The present invention relates to a multi-purpose framer's speed square having etched indicia in calibrated scales for rafter, angle, and linear measurements to facilitate the rapid marking of layouts for various standard dimensional construction materials, as well as marking cuts for King Studs and Trimmers.

### BACKGROUND OF THE INVENTION

There are numerous squares that are used in carpentry and construction, each configured for a particular task. The most common squares are the speed square, the combination square, the try square, the framing square, and the drywall square. The speed square is the most versatile tool, in the form of a right triangle having a flange on the base edge that can butt against a work edge to enable the user to draw a straight cut line or a 45° miter, the diagonal or hypotenuse edge has markings for laying out rafter, roof trim and stair angles.

Speed squares are useful to mark 45° angles and 90° angles, to serve as a saw guide for cross cuts, to measure and mark rafter angles, and to check for square on boards and framing.

A combination square is used for laying out lines for ripping, crosscutting, mitering, and making notches. The framing square commonly is used for laying out rafters and stair stringers while the try square is a fixed square for checking corners and edges. And the drywall square typically is used for laying out cut lines on standard size sheets of plywood, drywall, and other board materials.

Speed squares typically are used to cut lumber. More particularly, speed squares are designed to enable the marking of rafter cuts by aligning only one number, whereas the standard framing square requires the alignment of two numbers. The T-flange in the top edge of a speed square is placed against the edge of the lumber and holds the tool steady, thereby permitting speedy alignment of the tool. Speed squares combine many of the functions of the framing square and the protractor, and are more widely used than any other type of square.

However, there are disadvantages that are inherent to speed squares. When a speed square is used to make a plumb cut, an imprinted line on the square is visually aligned with the plumb cut, and the level cut is marked using the hypotenuse edge of the square. This often yields incorrect results because there is not a “STOP” to steady the square against the edge of the lumber when making the level cut.

### PRIOR ART

The prior art is replete with carpenter squares including speed squares that combine several features. For example, U.S. Pat. No. 5,170,568 to Wright, issued Dec. 15, 1992, relates to a roofing speed square having a right triangular shape wherein rafter base cut marks may be made in one step and rafter common marks may be made more easily with hip and valley measurements, but fails to provide a notched edge to facilitate scribing lumber. Similarly, U.S. Pat. No. 5,575,074 to Cottongim et al., issued Nov. 19, 1996, discloses a right triangular shaped speed square having marking scales along with a wrench-type means disposed within the square but without a notched edge. U.S. Pat. No. 5,727,325 to Mussell, issued Mar. 17, 1998, also is directed to a multipurpose square for cutting rafters, again without a notched edge. U.S. Pat. No. 8,122,609 B2 to Farr et al., issued Feb. 28, 2012, provides a step and rafter tool which comprises separate legs connected with bolts and wingnuts. U.S. Patent Application Publication 2006/0156558 A1 to Owens, teaches a multipurpose framing and layout guide kit having two components or guides.

Despite the many speed squares developed by the prior art, a need still exists for a multi-purpose framer's speed square which performs and simplifies many of the tasks previously accomplished by using multiple tools including the framing square, the try square, the combination square, the layout square and the protractor. Such a multi-purpose framer's speed square should include scribe line locations for easily and efficiently marking lumber, separate looking windows for the hip/valley rafter and the common rafter, and a notched edge to facilitate using the speed square for scribing lumber for ripping.

### SUMMARY OF THE INVENTION

The invention of the present subject matter relates to a multi-purpose framer's speed square in the form of a right triangle having a top plate with a T-shaped edge, a front edge which is notched and a hypotenuse for cutting rafters. The multi-purpose framer's speed square comprises etched indicia in calibrated scales for rafter, angle, and linear measurements and has a profile which facilitates the rapid marking of layouts for various standard dimensional construction materials, as well as marking cuts for King Studs and Trimmers.

Accordingly, it is an object of the present subject matter to provide a multi-purpose framer's speed square in the form of a right triangle having a top plate with a T-shaped edge, a notched front edge extending downwardly from one end of the top plate at a 90° angle, and a hypotenuse edge joining the top plate at a 45° angle and the notched front edge at a 45° angle.

It is another object of the present subject matter to provide a multi-purpose framer's speed square having a front face and a rear face, both etched identically with indicia in calibrated scales for rafter, angle, and linear measurements.

It is still another object of the present subject matter to provide a multi-purpose framer's speed square having a profile which facilitates the rapid marking of layouts for various standard dimensional construction materials, as well as marking cuts for King Studs and Trimmers.

It is a yet another object of the present subject matter to provide a multi-purpose framer's speed square comprising a notched front edge to facilitate scribing lumber for ripping, the notched front edge having lumber width callouts etched along the length thereof.

It is a further object of the present subject matter to provide a multi-purpose framer's speed square comprising a top plate with a T-shaped edge having a series of etched markings for easy scribing of top plate ear overhangs and partition layouts.

It is yet a further object of the present subject matter to provide a multi-purpose framer's speed square comprising a hypotenuse edge having top plate lines and common rafter window plumb cuts etched along the length thereof, and a hip/valley section having a looking window, a series of etched degrees, and etched hip/valley roof rafter plumb cuts markings.

It is still a further object of the present subject matter to provide a multi-purpose framer's speed square that is configured to be holstered or carried in the pocket of a standard tool apron to be readily accessible to the carpenter or framer.

It is an additional object of the present invention to provide a multi-purpose framer's speed square having a pivot point.

It is another object of the present subject matter to provide a multi-purpose framer's speed square having the placement of the common rafter markings at the hypotenuse (bottom) edge.

These and other objects of the present subject matter are accomplished by providing multi-purpose framer's speed square in the shape of a conventional right angle speed square having a top plate formed with a T-shaped edge, a notched front edge extending downwardly at a 90° angle from one end of the top plate, and a hypotenuse edge, joining the top plate and notched front edge at 45° angles.

### BRIEF DESCRIPTION OF DRAWINGS

FIG. 1 is a side perspective view of the multi-purpose framer's speed square of the present subject matter.

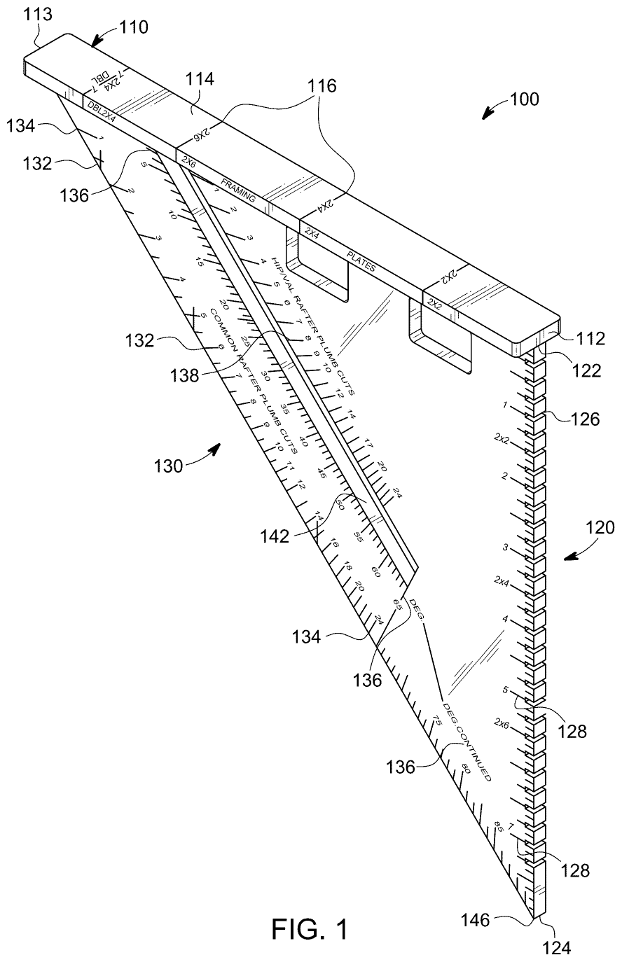

FIG. 2 is right side view of the multi-purpose framer's speed square of the present subject matter.

FIG. 3 is left side view of the multi-purpose framer's speed square of the present subject matter.

FIG. 4 is a top view of the multi-purpose framer's speed square of the present subject matter illustrating the top plate.

FIG. 5 a front view of the multi-purpose framer's speed square of the present subject matter illustrating the notched front side.

FIG. 6 is a top perspective view showing the multi-purpose framer's speed square of the present subject matter being used to measure a roof rafter having a 6″ rise and 12″ run.

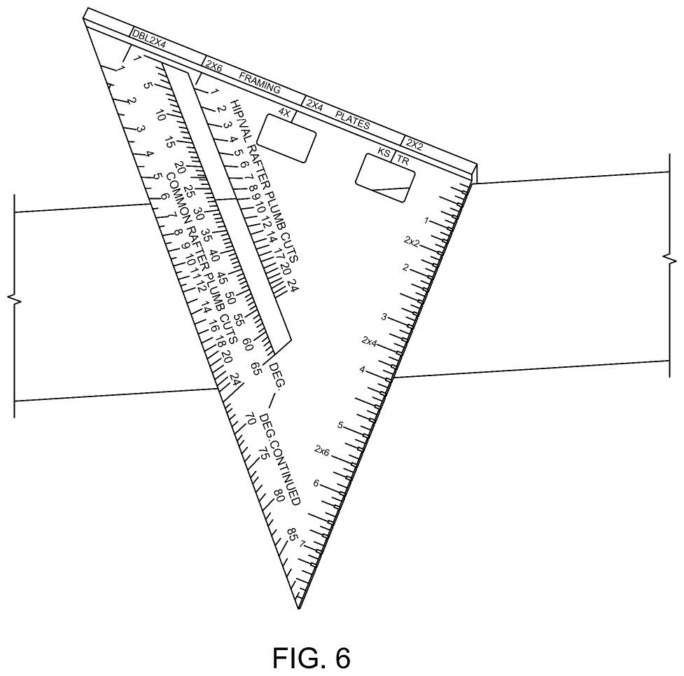

### DETAILED DESCRIPTION OF THE INVENTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements and are not drawn to scale. In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

The terms “framer's square”, “speed square”, “multi-purpose square”, and similar and derivative terms may be used throughout the specification and it is to be understood that such terms are interchangeable and all refer to the multi-purpose framer's speed square of the present subject matter.

Also, it is to be understood that the phraseology and terminology used herein is for the purpose of description and should not be regarded as limiting. The use of the terms “including”, “comprising”, “having”, and variations thereof herein is meant to encompass the items listed thereafter and equivalents thereof as well as additional items.

The present subject matter is directed a multi-purpose framer's speed square in the form of a right triangle having a top plate, a notched front edge extending downwardly from the top plate at a 90° angle, and a hypotenuse edge, joining the top plate and front notched side each at 45° angles. The multi-purpose framer's speed square further comprises a front surface face and a rear surface face, both surface faces being etched identically with indicia in calibrated scales for rafter, angle, and linear measurements.

Referring to the Figures, the multi-purpose framer's square of the present subject matter is shown in the form of a right triangle. More particularly, a multi-purpose framer's square 100 comprising a top side 110 having a first top end 111 and a second top end 113, a notched front edge 120 having a first end 122 which extends downwardly from first top end 111 at a 90° angle from the top plate, and a second end 124, a hypotenuse edge 130 having a proximal end 131 and a distal end 139, said proximal end 131 joined at a 45° angle 146 to said second end 124 of the notched front edge and said distal end 139 joined at a 45° angle 144 to the second top end 113 of the top plate 110. The multi-purpose framer's square 100 further comprises a front surface 102 and a rear surface face 106 with identical etchings of indicia in calibrated scales for rafter, angle, and linear measurements on both surface faces.

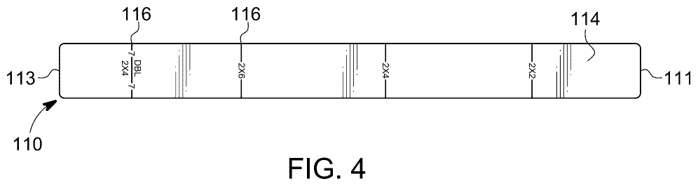

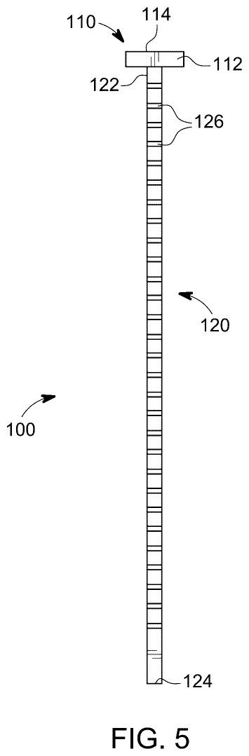

As best viewed in FIG. 4 and FIG. 5, the top plate 110 is formed with a T-shaped edge 112 extending outwardly along the length of the upper surface 114 of the top edge. As particularly shown in FIG. 4, along the upper surface 114 of the T-shaped edge is a series of etched markings 116 for easy scribing of top plate ear overhangs and partition layouts. This series of markings 116 may be referred to as the etched top plate lines. The markings 116 include framing top plate call outs, 2×2, 2×4, 2×8 and DBL 2×4. The T-shaped edge 112 is provided with rounded corners at both ends of its length.

Preferably, the rounded corners are one-sixteenth inch ( 1/16″) rounded corners.

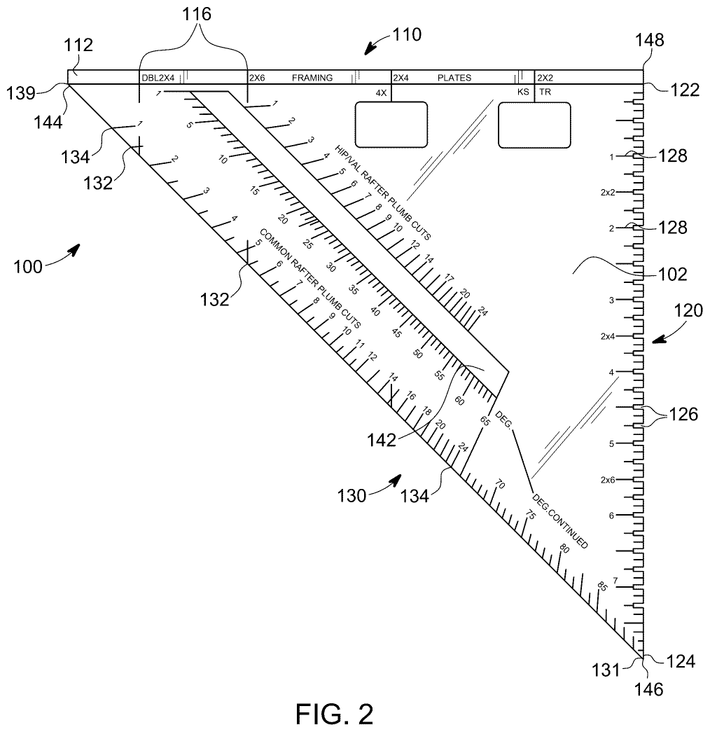

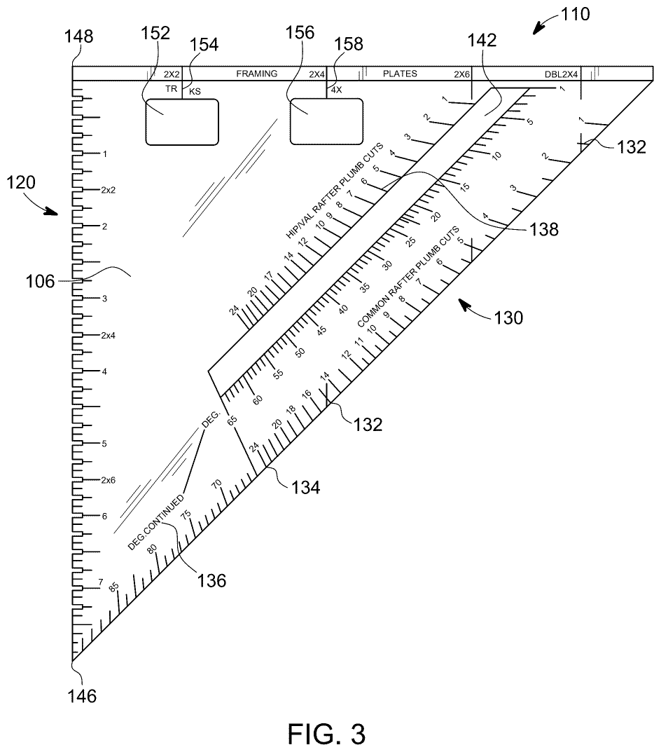

The notched front edge 120 of the multi-purpose framer's speed square comprises a plurality of notches 126 disposed on the length of the notched front edge as particularly shown in FIG. 5. The notches 126 are spaced along the edge length in one-quarter inch increments, ranging from one quarter inch (¼″) to seven-and-one-quarter inch (7¼″) cut outs, and etched ruler indicia 128 ranging from one-eighth inch (⅛″) to seven-and-seven eighth inch (7⅞″) callouts. The notches 126 facilitate using the speed square of the present subject matter for scribing lumber for ripping, the notches for the rip scribe cutouts are each one-sixteenth inch ( 1/16″) wide and one-eighth inch (⅛″) deep. Lumber width callouts 128 are etched along the length of the front side 120, the lumber width callouts denoting 2×2, 2×4, and 2×6 lumber sizes. The multi-purpose framer's speed square further comprises a pivot point 148 located at the 90° angle where the first top end 111 of the top plate 110 joins the first end 122 of the notched front edge 120 as best seen in FIG. 2 and FIG. 3.

The hypotenuse edge 130 is configured primarily for cutting rafters. One of the key factors in the configuration of the multi-purpose framer's speed square of the present subject matter is the placement of the common rafter markings along this hypotenuse (bottom) edge which eliminates any possible error in using the Hip/Valley angle to be used to cut a common rafter. Etched along the edge of the hypotenuse side are top plate lines markings 132, and common rafter window plumb cuts markings 134 with pitch markings from 1 through 24 and 12″. Disposed above the common rafter window plumb cuts markings 134 is a hip/valley looking window 142 used for measuring degrees and hip and valley rather plumb cuts, the looking window 142 being about ½″ wide. Below the looking window 142 are etched degrees markings 136, ranging from 1° to 65° at the looking window 142 and 65° to 89° along the proximal edge of the hypotenuse edge. Above the looking window 142 are hip/valley roof rafter plumb cuts markings 138, with pitches 1 through 24 and 16.97″

As best seen in FIG. 2 and FIG. 3, the multi-purpose framer's speed square of the present subject matter further comprises two looking windows disposed below the top plate 110. Above the first looking window 152 is an etched 2× King Stud and Trimmer layout marking 154 and above the second looking window 156 is an etched 4× King Stud and Trimmer layout marking.

It is conventional practice for the user to carry or holster a speed square somewhere on his/her person. Most contractors wear nail bags which are provided with a slot for carrying the speed square. In other instances, the speed square simply can be carried in the user's back pouch.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S.C § 112, sixth paragraph, unless the element is expressly recited using the phrase “means for . . . ” and no method or process step herein is to be construed under those provisions unless the step, or steps, are expressly recited using the phrase “step(s) for . . . .”

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. A multi-purpose framer's speed square in the form of a right angle triangle comprising:
a. a top plate having a T-shaped edge, a first top end, a second top end, and an upper surface having a series of etched top plate lines markings including framing top plate callouts;
b. a notched front edge having a first end and a second end, said first end of said notched front edge extending downwardly at a 90° angle from said first top end, said notched front edge having a plurality of notches spaced along the length thereof in quarter inch (¼″) increments, having etched markings ranging from one-eighth inch (⅛″) to seven-and-seven eighth inch (7⅞″) for ruler callouts, and lumber width callouts denoting 2×2, 2×4 and 2×6 lumber sizes;
c. a pivot point located at said 90° angle;
d. a hypotenuse edge having a proximal end and a distal end, said proximal end joined to said second end of said notched front edge at a 45° angle and said distal end joined to said second top end of said top plate at a 45° angle, said hypotenuse edge having top plate lines markings and common rafter window plumb cuts markings with pitches from 1 through 24 and 12″, and a hip/valley section disposed above said hypotenuse edge, and
e. a front face and a rear face, both etched identically with indicia in calibrated scales for rafter, angle, and linear measurements.

2. The multi-purpose framer's speed square in accordance with claim 1, wherein said framing top plate callouts are 2×2, 2×4, 2×8 and DBL 2×4 etched markings.

3. The multi-purpose framer's speed square in accordance with claim 1, wherein said plurality of notches along the length of said notched front edge range from one quarter inch (¼″) to seven-and-one-quarter inch (7¼″) cutouts.

4. The multi-purpose framer's speed square in accordance with claim 1, wherein said notches facilitate scribing lumber for ripping, said notches for the rip scribe cut outs each being about one-sixteenth inch ( 1/16″) wide and about one-eighth inch (⅛″) deep.

5. The multi-purpose framer's speed square in accordance with claim 1, wherein said hip/valley section disposed above the hypotenuse edge comprises a hip/valley looking window having etched degrees markings ranging from 1° to 65° below said hip/valley looking window and etched degrees markings 66° to 89° etched along the proximal length, and hip/valley roof rafter plumb cuts markings with pitches 1 through 24 and 16.97″ etched above said hip/valley looking window.

6. The multi-purpose framer's speed square in accordance with claim 1, further comprising a first looking window disposed below said top plate, said first looking window having an etched 2× King Stud/Trimmer layout marking and a second looking window disposed below said top plate, said second window having an etched 4× King Stud/Trimmer layout marking.

7. The multi-purpose framer's speed square in accordance with claim 1 which is configured to be carried in the pocket of a standard framer's tool apron.

8. The multi-purpose framer's speed square in accordance with claim 1, wherein the common rafter markings are placed along the hypotenuse edge.
